(19) United States
(12) Patent Application Publication
(10) Pub. No.: US 2009/0125206 A1
(43) Pub. Date: May 14, 2009

(54) Automatic detection and notification of turbine internal component degradation

(75) Inventors: Nicholas Tisenchek, Clifton Park, NY (US); Peter J. Eisenzopf, Altamont, NY (US)

Correspondence Address: NIXON & VANDERHYE, PC, 901 NORTH GLEBE ROAD, 11TH FLOOR, ARLINGTON, VA, 22203, US

(73) Assignee: GENERAL ELECTRIC COMPANY, Schenectady, NY (US)

(21) Appl. No.: 11/979,774

(22) Filed: Nov. 8, 2007

(51) Int. Cl. G06F 7/00; F01D 21/00; G06F 17/40; G07C 3/00

(52) U.S. Cl. 701/100; 702/185; 702/34

(57) ABSTRACT

An automated computer-implemented steam turbine engine monitoring and control arrangement provides continual monitoring and performs ongoing analysis of turbine system operational parameters to identify turbine internal component degradation. Current operational data for selected parameters are compared with accumulated past operational parameter data on a continuing basis to detect gradual changes occurring over an extended period of turbine operation. Based upon a comparison of some or all of the particular monitored turbine system operational parameters, and on the amount or rate of detected change occurring over time, a determination is made as to whether internal component degradation has progressed to a significant degree and to which particular turbine internal components are most likely to have incurred damage or degradation. A report or warning notification is then automatically generated which provides this information that maintenance planning and/or appropriate damage mitigation procedures may be implemented. In addition, the system also is configured to utilize the Internet or other communications network to allow turbine operator interaction with the monitoring system and access to information via a local on-site operator's control console or remotely via a web browser application interface over the Internet or other suitable communications network.

### BACKGROUND OF THE INVENTION

The subject matter disclosed herein relates generally to a method for automatic detection and warning of significant amounts of slowly occurring machine internal component degradation that may take place within a turbine engine system over time, and more particularly, to a computer controlled method of monitoring turbine engine system operational parameter data while continually diagnosing turbine engine condition over a period of time to automatically identify, track and provide early warning of turbine engine internal component degradation.

In the field of steam/gas turbine engineering operation and maintenance, it is highly desirable to be able to detect and recognize symptoms turbine component degradation at an early stage so as to plan and implement corrective or preventive maintenance procedures. In the past, turbine operational parameter data has been used to diagnose certain specific turbine operational fault conditions that are indicative of the occurrence of a particular damage event. However, there are no known conventional approaches or commonly implemented methods for detecting a progressive performance degradation that may slowly occur over an extended period of time and/or for detecting a cumulative effect of one or more minor damage incidents. Moreover, there is no known conventional approach or method for efficiently diagnosing and collecting such damage and degradation events that provides turbine operators with a notice or warning that is sufficiently early enough to aid in the planning and implementation of preventive maintenance procedures. As a steam/gas turbine operates, blades, seals, components within the steam path and other internal portions/components are subject to continual wear and degradation due to such things as, for example, the deposition of hard minerals from the coolant fluid, damage incurred from inadvertent introduction of foreign objects/particles, wear caused by unforeseen events, etc. Although most major operational change events are typically obvious and easily detected by a turbine engine system operator, many incremental and gradually occurring degradation events can easily go unnoticed. The continually occurring degradation of internal components results in gradual and incremental changes in a turbine's overall conversion efficiency and power output that may not be immediately noticeable or even detectable by an operator. As such, a turbine operator has no accurate way to assess the condition of the turbine's internal components until or unless the turbine is shut down and opened for inspection or repair. Consequently, because of this lack of accurate information concerning the instantaneous state of internal components due to ongoing and gradually occurring degradation, the maintenance and overhaul of turbine engine systems can not be planned or scheduled for times that would maximize its effectiveness. Accordingly, there is need for a system and method that can continuously monitor and detect gradually occurring changes in a turbine engine system's operational parameters, automatically identify meaningful or significant changes in specific parameters that are indicative of internal component degradation, and then automatically generate a notification or warning to a turbine operator when the degradation reaches a significant or predetermined meaningful level. Moreover, there is a need for an automated monitoring and warning generation/notification system for detecting gradually occurring internal component degradation in turbine engine systems that is also capable of being implemented and accessed over the Internet or via other suitable WAN/LAN communications link.

### BRIEF DESCRIPTION OF THE INVENTION

A method and system for providing for the automatic monitoring, detection and notification of turbine engine internal component degradation is disclosed so as to facilitate a more effective planning and implementation of scheduled maintenance procedures. In addition, a computer implemented method and computer program product containing computer executable instructions is disclosed for implementing a process of providing a turbine operator with early notice and warning of meaningful/significant changes in turbine operational parameters that may gradually occur changes over a predetermined period of turbine operation. In particular, a non-limiting example implementation is disclosed that provides ongoing continual monitoring, comparison and evaluation of turbine operational parameters so as to identify any meaningful/significant gradually occurring changes that are indicative of internal component degradation and/or cumulative damage and which automatically generates notification or warnings of degradation events or trends that are communicated to a turbine operator. In addition, a non-limiting example implementation is disclosed that provides operator interaction with the monitoring system and access to information via a local on-site operator's control console or remotely via a web browser application interface over the Internet or other suitable communications network.

### BRIEF DESCRIPTION OF THE DRAWINGS

FIG. 1 is an general schematic illustration of an example opposed-flow steam turbine and control system arrangement therefore;

FIG. 2 is a high-level process flow diagram illustrating a non-limiting example process for the automatic detection and warning of slowly occurring internal degradation in a turbine machine; and

FIG. 3 is a detailed flowchart illustrating an exemplary computer implemented method for the automatic detection and warning of slowly occurring internal degradation in a turbine machine.

### DETAILED DESCRIPTION OF THE INVENTION

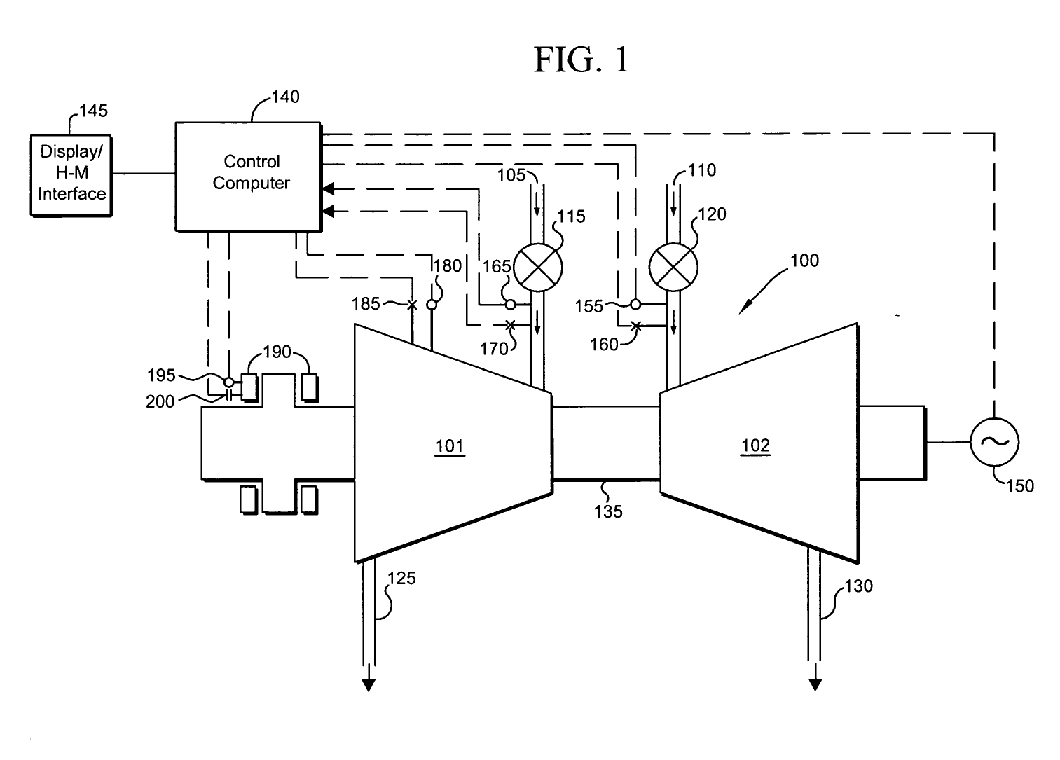

FIG. 1 illustrates a conventional opposed-flow steam turbine engine and associated control system. In this example utilization, opposed-flow steam turbine system engine 100 is provided to rotate a rotor shaft 135 connected to a generator 150 to generate electrical power. In operation, steam provided by a steam generator (not shown) is introduced into a first subassembly/section 101 of turbine engine 100 by inlet pipe 105 controlled via steam inlet control valve 115. Steam entering into turbine section 101 expands and causes rotation of rotor shaft 135 before exiting at exhaust outlet 125. Typically, the steam exhausted at outlet 125 is returned to the steam generator where it is reheated and then reintroduced into a second subassembly/section 102 of turbine engine 100 via inlet pipe 110 which is controlled via a second inlet control valve 120. Reheated Steam introduced into turbine second subassembly/section 102 again expands imparting additional rotational forces to rotor shaft 135 before exiting through exhaust outlet 130 and being returned to a condenser unit (not shown).

Energy taken out of the steam by turbine engine 100 is converted to electrical energy by generator 150 connected to turbine rotor shaft 135. Conventionally, turbine rotor shaft 135 is held in place by an axial thrust bearing assembly 190. During operation of the turbine, various operational parameter are monitored and recorded. For example, referring to FIG. 1, steam temperature may be monitored by temperature sensors 160, 170 and 185, steam pressure maybe monitored by pressure sensors 165, 155 and 180, and output power produced may be monitored at electrical generator 150 output. Thrust bearing 190 temperature may also monitored by a temperature sensor 195 and a bearing load may be monitored by a thrust bearing load sensor 200.

As depicted in FIG. 1, an on-site turbine system control computer 140 is used for monitoring turbine instrumentation and controlling operation of the turbine. Conventionally, control computer 140 controls operation of valves 115, 120 to control the electrical generation rate of the generator 150. Control computer 140 is operably coupled to valves 115, 120, pressure sensors 155, 165, 180, 195 and is configured to generate control signals to control an operational position of steam inlet valves 115 and 120. Control computer 140 is also configured to monitor steam pressure signals from steam pressure sensors 155, 165, 180 and is configured to compute and control steam pressures in conduits 105 and 110 based upon the monitored pressure signals. In addition, control computer 140 may be configured to monitor the axial force exerted by the rotor shaft 135 against the thrust bearing 190 provided by pressure sensor 195. Turbine control computer 140 includes a human-machine interface for controlling operation of turbine system 100. The human-machine interface provided may be of varying form or type but typically includes a control panel and an operator interface/display 145 which functions as a primary control center for the turbine engine and power generation system. In the non-limiting example implementation disclosed herein, computer 140 is configured to continuously monitor turbine operational parameter data provided by the above mentioned sensors and/or other instrumentation. Computer 140 is also coupled to a private WAN/LAN communications network or the Internet and is configured to be accessible via a conventional web-browser application for communicating operational status and sensor data to a remote location or server.

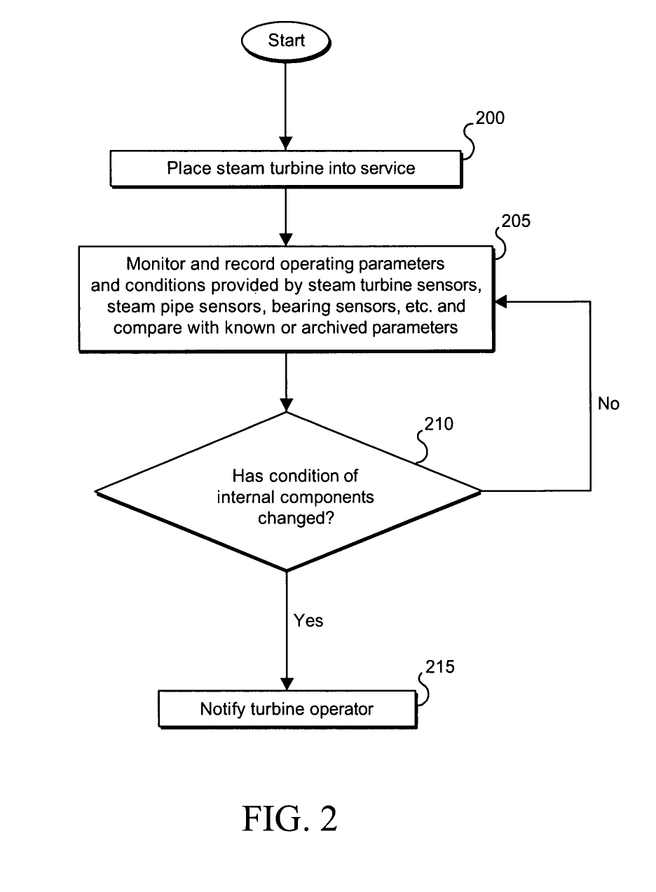

In FIG. 2, a high-level process flow diagram illustrates a basic overview of a non-limiting exemplary process for implementing automatic detection and warning of gradually occurring turbine internal component degradation. Once a steam turbine is placed into service, as indicated at step 200, operational conditions and parameters are continually monitored and recorded by a plurality of sensors, as indicated at block 205. The monitored turbine operational parameters are continually compared with operational parameter values previously recorded from the same turbine system/machine operating under the same operating conditions over a predetermined period. During operation, a determination is made, as indicated in block 210, as to whether the monitored parameters exhibit significant or meaningful differences from the previously monitored and recorded parameters. If significant or meaningful differences or a trend in the recorded parameter changes are detected and are indicative of turbine performance degradation or internal component degradation, an analysis is performed to identify the most probable turbine components/subsystem suffering from degradation and a warning or notification is logged and provided or made accessible to the turbine system operator, as indicated at block 215. A notification may be communicated by computer 140 (FIG. 1) via the Internet or via private WAN/LAN communications infrastructure as appropriate. For example, the notification may be implemented by sending or posting a conventional email type message to predetermined recipient destination address and/or the notification may be provided to a secure server that maintains turbine operational information and provides on-line access via a conventional web-browser or other interfacing application for a turbine operator or other approved users to turbine operational information such as system warning notifications, turbine operational status, operational parameter data and history, and other operational information.

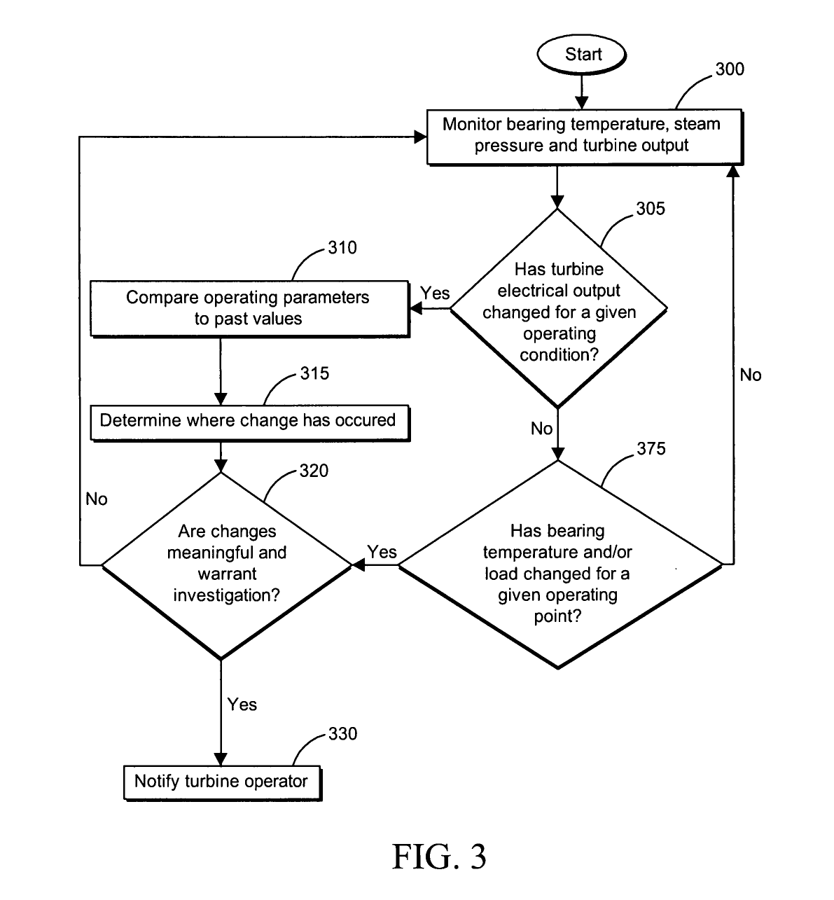

Referring now to FIG. 3, a more detailed flowchart illustrating non-limiting exemplary steps performed by a control computer for the automatic detection and warning of slowly occurring turbine internal component degradation is provided. As mentioned above, a beneficial aspect of the following exemplary method is that the turbine system owner/operator is notified as to the cause and extent of turbine performance degradation and component wear and/or slowly accumulating component damage as soon as the wear or damage becomes meaningful and well before the wear or damage results in a systemic failure. At step 300, control computer 140 monitors various operational parameters of the turbine engine during its operation, such as, thrust bearing temperature, steam pressure, turbine output, steam temperature, thrust bearing load, etc. As indicated in decision step 305, control computer 140 determines whether any of the parameters being monitor have changed for a given predetermined turbine operating point/condition. If so, the operating parameters are compared to past values for the same parameters as indicated in block 310, and a determination is made as to what part or component of the turbine is the most likely cause of the parameter change, as indicated at block 315. As indicated in block 320, if comparison of past operating parameter values indicate that current changes in the parameter values are meaningful and warrant further investigation, then a warning or notification is provided at an operator display interface 145 (FIG. 1) and/or sent to a remote secure server that maintains turbine operational information and provides on-line access to that information as described above.

If detected changes to operating parameters are less then a predetermined significant/meaningful difference or are within a predetermined margin of measurement error, the detected changes are logged for performing future trend analysis and monitoring of parameters is continued as indicated in block 300. As indicated in decision block 305, if turbine electrical output has not changed for a give operation condition, then other operational parameters such as steam temperature and/or bearing temperature and/or bearing load is checked to determined has changed for a given operating condition, as indicated in block 375. If these changes have been determined in block 320 to be significant or meaningful enough to warrant further investigation then the turbine operator is immediately notify via a display interface 145 (FIG. 1).

The technical effect of the above described non-limiting example implementation is an automatic system for monitoring, detecting and warning of meaningful/significant changes in turbine engine operational parameters that appear or accumulate gradually over an extended period of time which are indicative of turbine internal component degradation for providing a turbine engine operator with early notice and/or warning of the degradation, so as to facilitate planning and implementation of maintenance procedures.

As described above, an implementation of the invention may be embodied in the form of computer-implemented processes and apparatuses for practicing those processes. An implementation of the invention may also be embodied in the form of computer program code containing instructions embodied in tangible media, such as floppy diskettes, CD ROMs, hard drives, or any other computer-readable storage medium, wherein, when the computer program code is loaded into and executed by a computer, the computer becomes an apparatus for practicing the claimed invention. An implementation of the invention may also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and/or executed by a computer, the computer becomes an apparatus for practicing the claimed invention. When implemented on a general-purpose microprocessor, the computer program code segments configure the microprocessor to create specific logic circuits (i.e., programmed logic circuitry).

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A system providing automatic detection and warning of component degradation occurring within a turbine engine power generation system over time, the turbine system comprising a control computer and a computer-readable storage medium having stored thereon computer program instructions executable by said control computer, the computer program instructions causing said turbine engine power generation system control computer to:
monitor and record one or more turbine operational parameters over a predetermined period of time;
compare values of current operating parameters with previously recorded parameter values and identify operating parameter that have undergone a significant change in value; and
generate a warning notification regarding operational parameter identified as having undergone a significant change.

2. The turbine engine power generation system of claim 1, wherein said computer program instructions further cause said control computer to determine whether turbine electrical output power has changed by a predetermined amount over a predetermined time period for a predetermined turbine operating condition.

3. The turbine engine power generation system of claim 1, wherein said turbine operational parameters include at least one of steam pressure, thrust bearing temperature, thrust bearing load or electrical power output.

4. The turbine engine power generation system of claim 1, wherein said control computer is coupled to the Internet or a private WAN/LAN communications network and said computer program instructions enable said control computer to be accessible from a remote location via a conventional web-browser for communicating said notification and/or other turbine system operational information.

5. The turbine engine power generation system of claim 1, wherein said control computer is coupled to the Internet or a private WAN/LAN communications network and said computer program instructions further cause said control computer to communicate said notification to a secure server that maintains turbine operational information and which provides on-line access to said information via a conventional web-browser.

6. A system for automatically detecting and providing notification of turbine internal degradation, comprising:
a turbine machine having a plurality of sensors for monitoring operational parameters; and
a turbine control computer including diagnostic computer code stored in said computer for monitoring values of predetermined turbine operating parameters and generating a warning notification if any of said monitored parameters deviate by a predetermined amount from operational values observed during a predetermined previous period of turbine operation.

7. The system of claim 6 wherein said computer code instructions further causes said control computer to determine whether turbine output power has changed by a predetermined amount over a predetermined time period for a predetermined turbine operating condition.

8. The system of claim 6 wherein said turbine operational parameters include at least one of steam pressure, thrust bearing temperature, thrust bearing load or electrical power output.

9. The system of claim 6 wherein said computer is coupled to the Internet or a private WAN/LAN communications network and the notification is communicated automatically to a predetermined remote location via email.

10. The system of claim 6 wherein said computer is coupled to the Internet or a private WAN/LAN communications network and is configured to be accessible from a remote location via a conventional web-browser for communicating said notification and/or other turbine system operational information.

11. A method for automatic detection of turbine internal degradation, comprising:
monitoring and recording one or more turbine operational parameters for a particular operating point over a predetermined period of turbine operation;
comparing recent monitored turbine operational parameter values with previously observed operational parameter values and identifying operating operational parameters that have undergone a significant change; and
generating a warning notification if an operational parameter is identified as having undergone a significant change indicative of internal component degradation.

12. The method of claim 11 further comprising steps of:
determining whether turbine system electrical output power has changed by a predetermined amount over a predetermined period of turbine system operation, and
generating a warning notification if turbine system electrical output power has changed by said predetermined amount over said predetermined period of turbine system operation.

13. The method of claim 11 wherein said turbine operational parameters include at least one of steam pressure, thrust bearing temperature, thrust bearing load or electrical power output.

14. The method of claim 11 wherein said notification is communicated via Internet connection to a predetermined recipient.

15. The method of claim 11 wherein said notification is provided to a secure server that maintains turbine operational information and provides on-line access via a conventional web-browser.
